(19) United States
(12) Patent Application Publication
(10) Pub. No.: US 2013/0324654 A1
(43) Pub. Date: Dec. 5, 2013

(54) Multipurpose Water Based Composition and Film Composition from a Water-Based Emulsion

(71) Applicant: Ike Banoun, Los Angeles, CA (US)

(72) Inventor: Ike Banoun, Los Angeles, CA (US)

(21) Appl. No.: 13/893,041

(22) Filed: May 13, 2013

Related U.S. Application Data
(60) Provisional application No. 61/646,008, filed on May 11, 2012.

(51) Int. Cl. C09D 129/04; C09D 121/02

(52) U.S. Cl. CPC C09D 129/04; C09D 121/02
USPC 524/363; 524/503

(57) ABSTRACT

A series of compositions, water based and solvent based, and a film composition from a water-based emulsion that yield substantially removable coatings disposed to be applied to the surface of numerous objects, including vehicles. The coatings allow for easy application and removal. These durable and easily applicable compositions may be dispensed in rollable, sprayable or hand stretch applied form, and no preparation to the surface is required.

### CROSS REFERENCE TO RELATED APPLICATION

This application claims the benefit of and takes priority from U. S. Provisional Patent Application Ser. No. 61/646,008 filed on May 11, 2012, the contents of which are herein incorporated by reference.

### FIELD OF THE INVENTION

The present invention relates to surface coatings and particularly to paint utilized for automobiles and numerous other applications.

### BACKGROUND OF THE INVENTION

Coatings, paints and protective layers currently represent a burgeoning in industry in a time when consumers expect the most from an investment. Additionally, automobile detailing is a large and growing industry. Automobile body shops across the country provide professional paint jobs that allow their customers to customize their cars. Currently, there are some at home paint and detail kits but these kits require spray equipment, can yield low quality results, are costly, and are permanent. Some of the concurrent coatings are solvent based and thus unsafe and dangerous to users.

The known at home paint and detail kits are not user friendly. Most paints will run or easily leave imperfections if a consumer is not trained in paint equipment or is not meticulous in preparation and use. These kits are also costly and time consuming. Furthermore these kits create a permanent coat of adhesive paint on the automobile body.

Likewise body shops that perform these car wraps, or new coats of paint and paint designs, are permanent. The current technology uses an adhesive layer of paint that creates a permanent bond with the body of the automobile. This adhesion is only overcome by professional grade chemicals or repainting the automobile again.

There is a need in the art for a paint wrap that is easy to use, durable, cost effective, and flexible as far as changeability.

### SUMMARY OF THE INVENTION

It is a primary object of the instant formulation to introduce a series of object surface wraps, paints and coatings. These durable and easily applicable compositions may be dispensed in rollable, sprayable or hand stretch applied form, and no preparation to the surface is required. It is therefore a primary object of this product to provide a paint that is easy to apply, long lasting, inexpensive in the market, and removable.

It is a further object of this product to allow for customization and creative freedom. The subject composition results from the realization that the current paint technologies requiring recoating and complex chemicals are limiting the automotive industry from customization, ease of repairs, and automotive restoration.

It is a further object of this product and system to reveal a film composed of a water based emulsion which can be sprayed wet and then it forms a film on a vehicle or other applicable object.

The instant product may feature a paint possessing the capability of being removed by simply peeling it away from the surface that is coated. These stretch technologies allow the paint coat to remove in large quadrants and without the use of chemicals and excessive tools, thus making the removal process fast and efficient. The paint product may be packaged in gallon and quart systems, in aerosol cans, all with instructions for use. This paint can be applied using a spray gun, a roller, a brush, or any other paint tool as the paint technology allow for self-settling. The paint can be applied to a variety of surfaces including windows, tires, metal, and plastic. The paint can be used for detail work as it is easy to cut away sections that have been coated to reveal trim or other features.

The paint can be customized into a variety of colors including the possibility of photo luminescence and scented paints. Once a coat of the peelable paint has been properly applied, additional layers of this product or other paint and design products can be applied over it and the wrap will still easily peel away. This allow for further customization, such as graffiti and other art forms expressed over the top of the peelable paint surface and then removed in total. The paint can come in matte or glossy surfaces as well as other paint finishes.

The instant system may also act as a peelable base wherein other paints or substances may be applied over the peelable coat for easy removal.

It is also an objective of the instant formulation to introduce a series of object surface film coatings or paint film coatings.

Another feature of the instant design is its durability. It can be washed, and will withstand natural weather elements as well as heat and cold conditions.

In one embodiment, a water based coating composition is disclosed comprising a quantity greater than fifty percent by weight water, and a quantity of less than fifty percent emulsion resin. Additionally, the water based coating composition may further include at least one additive, wherein preferably the additive comprises a water reducible additive for latex coatings or a quantity of a floetrol® substance. In yet another embodiment, the water based coating may be placed on flocked vinyl. In yet another embodiment, the water based coating composition comprises a film composed of a water based emulsion.

In another embodiment, a solvent based peelable coating composition is disclosed comprising a quantity of less than 60 percent Methyl Ethyl Ketone, a quantity of greater than 30 percent Methyl Isobutyl Ketone and, a balance of 25-35. Furthermore, the peelable film solution may comprise a range of 40-60 percent vinyl polymers by weight and a range of 50-60 percent water by weight. Additionally, the peelable film solution adheres to a surface with an adhesive medium.

In yet another embodiment, a spray film coating is disclosed wherein the coating comprises a solution of less than fifty five percent water by weight; a solution of fifty percent acrylic polymer emulsion by weight; and, a solution of in a range two to six percent non-regulated additives. Furthermore, the spray film coating preferably adheres to a surface with an adhesive medium.

There has thus been outlined, rather broadly, the more important features of the multipurpose water-based composition and embodiments in order that the detailed description thereof that follows may be better understood, and in order that the present contribution to the art may be better appreciated. There are additional features of the apparatus that will be described hereinafter and which will form the subject matter of the claims appended hereto.

In this respect, before explaining at least one embodiment of the apparatus in detail, it is to be understood that the apparatus is not limited in its application to the details of construction and to the arrangements of the components set forth in the following description or illustrated in the drawings. The apparatus is capable of other embodiments and of being practiced and carried out in various ways. Also, it is to be understood that the phraseology and terminology employed herein are for the purpose of description and should not be regarded as limiting.

These together with other objects of the system, along with the various features of novelty, which characterize the system, are pointed out with particularity in the claims annexed to and forming a part of this disclosure. For a better understanding of the system, its operating advantages and the specific objects attained by its uses, reference should be made to the accompanying drawings and descriptive matter in which there are illustrated preferred embodiments of the system.

### DETAILED DESCRIPTION OF THE INVENTION

The detailed description set forth below is intended as a description of presently preferred embodiments of the invention and does not represent the only forms in which the present invention may be construed and/or utilized. The description sets forth the functions and the sequence of the steps for producing the invention. However, it is to be understood that the same or equivalent functions and sequences may be accomplished by different embodiments also intended to be encompassed within the scope of the invention. The instant apparatus and system, as illustrated herein, is clearly not anticipated, rendered obvious, or even present in any of the prior art mechanisms, either alone or in any combination thereof. Thus the several embodiments of the instant apparatus are illustrated herein.

The unique characteristic of the present system entail flexibility in application and ease in removability of coatings and paints in application to many products including vehicles, toys, sporting goods, military equipment as well as numerous other goods.

In an embodiment possessing additional properties, the instant composition which does not require any form of added affixing agent, illustrating the water based composition being applied to a vehicle edge. In another embodiment, the water-based composition exemplifies the versatility afforded the user by the instant composition and system by illustrating the ability to quickly change the color and overall aesthetic value of vehicles by introducing easily removable vehicle paints afford the user. Thus, the versatile nature of the instant composition allows the user the opportunity to possess a respectable vehicle for the requirements of professional applications and then alter the look somewhat or in the entirety for occasions when a more exciting or flashy look is desired.

These coatings may also provide for quick patching of chipped or scraped areas of vehicles, particularly due to the easy and speed with which the instant invention can be applied. This coating can be manufactured in embodiments which require affixing agents or do not require affixing agents. All common affixing agents such as, but not limited to, glues, tapes or pastes may be utilized. Additional embodiments include bonding impetuses such as heat sensitivity or pressure sensitivity upon application to the surface for attachment.

In other embodiments or utilities of the instant composition, the instant water based composition may be utilized in sports gear and for bulletproof lining applications. The flexibility and strength of the instant composition allows for layered application in order to build strength and durability.

In yet another embodiment of the instant invention comprises as a peelable paint system, applicable to adults and children alike. This embodiment exemplifies a paint-on-paint application which fully realizes the abilities of the instant composition to introduce a medium which can be removed from the actual paint from the medium. Thu, you have removable and relocateable art forms; once again, the peelability of the domestic application, which is particularly pertinent for children's applications.

The instant composition may comprise a latex paint wrap or spray paint and a substantially adhesive cling wrap paint, without utilizing an external adhesive mechanism. In the essence, the instant composition exhibits the strength and longevity properties of a latex house paint, with the versatility to cover a car or other product in a simulated car wrap fashion. Additionally, when formed on an object, the instant peel paints can be removed whenever the user desires by simply cutting into the paint and peeling away the desired area.

It is an additional sprayable wrap, the formula may be a silicone based coating which is designed to actually turn into a film that looks and acts like films of today, minus the adhesive. Due to the peelablility properties, the user need just spray the entirety of the vehicle—the glass, rubber, metal and plastic—then just cut and peel away the unrequired or unwanted parts. In fact, even the vehicle logos can be cut away. The instant composition may be blended to create paints in hundreds of colors, and may also be produced in gloss or matte, all providing the same ease of application and removal.

Unlike any concurrent formulations, the instant composition comprises a water based emulsion. Thus, this composition does not create any bubbling and the smallest of corner areas can be tackled with ease. Therefore, the entirety of a vehicle or other object can be covered in mere hours. The film that is formed after the instant composition is sprayed or applied can be now be top coated with chrome or other effect paints.

Thus, the user can, in fact, create a different film and change the look of a vehicle, or other object, as often as preferred. Further, due to the substantially perfect adhesion qualities, the paint will last for years if the user so desires. In regard to quantities for application, in order to cover an average sedan, approximately a gallon and half of the solution would be required. Thus, the instant solution qualifies as extremely cost effective as well as versatile.

In an additional embodiment, a peelable spray film coating in the water soluble vinyls family is introduced. The solution may be composed of a range of 40-60 percent vinyl polymers by weight and a range of 50-60 percent water by weight. In a similar additional embodiment water soluble vinyls family, another peelable spray film coating is introduced and this compound may comprise a solution of less than 55 percent water by weight, 50 percent acrylic polymer emulsion by weight and 2-6 percent non-regulated additives. This film comprises the capability to cling with no adhesive additive and particularly clings to non-porous surfaces. Such features and properties are clearly novel in films space, particular in the automotive industry.

Furthermore, the instant film can be utilized with a plethora of products, including cling wrap to used in conjunction food products as it is food safe. Further, as the instant material includes no PVC and instant comprises latex and PVA, microwaving will present no ill effect. Furthermore, the instant material can be manufactured inexpensively in order to render it with a greater commercially viable value.

Thus, the instant composition replaces PVC film with latex and PVA which performs better, possesses greater Green or environmental properties as the composition is composed of latex and can be manufactured for half the price. The instant composition may come in a film, 3 mils (75 microns) and 60 inches wide and can even be utilized for clothing, to wrap cars, cabinets, or helmets. The instant composition performs like a Velcro® paint which is easily removable and repositionable, and does not diminish in ability to cling or clingability on numerous applications. Furthermore, the instant composition can be manufactured in various colors and special effects.

Thus, as there PVV and no glue in the formulation, all the user need do is press the material in place with no plastic deformation. Furthermore, the instant material of manufacture may even be applied in cold temperatures with no requirement of use of a heat gun or the like. And, the instant article of manufacture may also be printed on just like vinyl films, is as durable as exterior latex paints and can be produced in an endless range of colors and special effects, can match any Pantone or RAL color. Further, due to the development of the processes herein, the instant article of manufacture and thus can be manufactured at a very low price.

Thus, the instant composition thus envisions authentic vehicle paint on film that is soft to the touch. Softouch^{TM} wrap film, a new matte which can be used inside, outside and even on the wheels of a vehicle. The surface will be soft to the touch, but unscratchable. Hundreds of colors, even clear overlaminate. The instant material comprises more matte than any film and guaranteed to stay matte. The extremely touch and available in 60″ rolls. On the gloss scale, SofTouch™ is a zero, whereas, normal matte is a 12, this qualifies as a super matte. Further, the instant material does not show marks or stone chips. SofTouch™ is approximately 100 times more resistant to marking, peeling and scratching.

In one embodiment, the instant film evinces extreme ease of application as the film possesses Thermoformable properties. It can even be utilized as a point of purchase display coating. Computer component and iPhone/droid covering, musical instruments, appliances, air egress technology, all with no bubbling may be covered and the instant material can be sprayed or vinyl wrapped. SofTouch™ can be applied to Arlon, Avery, 3M or any brand of film wrap.

A coating that becomes a film for nails, wherein once the film is formed after a few minutes, it can be removed but its key point is that it can endure through showers and daily life and comes off when pealed. And the instant material can peel off the skin separately than the nail, if carefully peeled off and can be produced in any color, high gloss or low gloss. The instant material can also be top-coated with existing coatings or nail polish and may utilize most of Alsa® special effects. Thus, the instant material produces any color on earth, with no solvents and is thus totally green as the instant material may be composed of poly vinyl acetate and acrylic polymers and will be suspended in water, as a water-based emulsion. And, in an additional embodiment, the same water based emulsion may rendered into a film by the use of release paper.

Moreover the instant formulation, product and system reveals a film composed of a water based emulsion which can be sprayed wet and then it forms a film on a vehicle or other applicable object. The novelty in creating a film from a water-based emulsion that can be applied in numerous manners is clearly evident within the coating and paint arts. The instant formulation may be wet sprayed, brushed or rolled on for convenience. Thus, the instant formulation may be applied in dry film in rolls which is not to be sprayed, this acting as a stick on paint or a “Velcro® of paint”.

In an additional embodiment, the instant water based emulsion may be utilized to create a skin for packing for a vehicle and the like. Also, the instant formulation may be used on jewelry boxes, counter top displays such as cosmetic displays and watch displays and be altered to be in the form of gloss all the way to mat. The film composed of a water based emulsion may also be utilized to coat another layer of material, such as paint and may also be removably applied. Thus, the instant formulation may be applied and removed in much the same manner as an everyday Bandaid® bandage.

The instant material represents a water based paint which creates a film, whether rolled by industrial machine or applied in another manner and which cleans with soap and water. The film also colors, fades and blends and can be scented with such flavors as pinecone, vanilla, leather, sea breeze and others.

1. A water based coating composition comprising:
a quantity greater than fifty percent by weight water; and
a quantity of less than fifty percent emulsion resin.

2. The water based coating composition of claim 1 further comprising at least one additive.

3. The water based coating composition of claim 2 wherein the at least one additive comprises a water reducible additive for latex coatings.

4. The water based coating composition of claim 2 wherein the at least one additive comprises a quantity of a floetrol® substance.

5. The water based coating composition of claim 2 wherein said composition may be placed on flocked vinyl.

6. The water based coating composition of claim 1 wherein the water based coating composition comprises a film composed of a water based emulsion.

7. (canceled)

8. A peelable film solution comprising:
a range of 40-60 percent vinyl polymers by weight; and,
a range of 50-60 percent water by weight.

9. The peelable film solution of claim 8 wherein the peelable film solution adheres to a surface with an adhesive medium.

10. A spray film coating comprising:
a solution of less than fifty five percent water by weight;
a solution of fifty percent acrylic polymer emulsion by weight; and,
a solution of in a range two to six percent non-regulated additives.

11. The spray film coating claim 10 wherein the spray film coating adheres to a surface with an adhesive medium.
